(19) United States
(12) Patent Application Publication
(10) Pub. No.: US 2009/0162508 A1
(43) Pub. Date: Jun. 25, 2009

(54) Juice Extractor

(75) Inventor: Graeme Howard Davies, London (GB)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Royal College of Art, London (GB)

(21) Appl. No.: 12/338,640

(22) Filed: Dec. 18, 2008

Related U.S. Application Data
(63) Continuation-in-part of application No. PCT/GB2007/002189, filed on Jun. 13, 2007.

(30) Foreign Application Priority Data
Jun. 21, 2006 (EP) 06253197.5
Jun. 21, 2006 (GB) 06253197.5

(51) Int. Cl. A23L 1/20; A47J 19/02

(52) U.S. Cl. 426/481; 99/501; 99/502

(57) ABSTRACT

A method and apparatus is described for pulping/liquidising the edible flesh within a fruit, especially a citrus fruit. The apparatus includes a blade that is attached at its middle to a shaft that is rotatable about a longitudinal axis. The blade is pivotable to the shaft and is inserted tip first into the fruit while it lies parallel to the shaft so that the size of the opening into the fruit can be minimised. The shaft is rotated about its longitudinal axis and, while the shaft is rotating, the blade is pivoted outwardly from the shaft. The rotary movement of the shaft and the pivoting of the blade means that the blade traces a three dimensional shape within the fruit and thereby pulps it.

### CROSS-REFERENCE TO RELATED APPLICATIONS

This application is a continuation-in-part of International Application No. PCT/GB2007/002189, filed Jun. 13, 2007, which International application was published on Dec. 27, 2007, as International Publication No. WO 2007/148049 A1 in the English language, which application is incorporated herein by reference. The International application claims priority of European Patent Application No. 06253197.5, filed Jun. 21, 2006, which application is incorporated herein by reference.

### TECHNICAL FIELD

The present invention relates to a method and apparatus of pulping the edible flesh within a stoneless fruit especially a citrus fruit and most especially an orange. The pulped fruit can be extracted from the fruit either directly after pulping or following a storage time.

### BACKGROUND ART

It is generally well established that the consumption of fruit is beneficial and healthy and various health agencies encourage the consumption of more fruit. Oranges are particularly good source of nutrition and provide a large amount of vitamin C. However, oranges can be difficult to peel and many people cannot be bothered to eat oranges as the whole fruit. Accordingly, most oranges are consumed in the form of orange juice, which can include some of the fibre from the orange but more often is filtered to exclude such fibre. Orange juice is traditionally made by cutting the orange in half and pressing the cut orange against projection to squeeze the juice out of the orange. Alternatively, the cut orange can be squashed to squeeze the juice out of the orange. However, many of the health benefits from an orange are to be found in the nutrients lying close to the skin of the orange and in the fibrous flesh. The above methods of juice extraction often find it difficult to extract the fruit close to the skin and generally do not extract the fibrous flesh.

More recently, there has been a trend to drink liquidised fruit (sometimes called “smoothies”) where whole fruits/vegetable are liquidised whole. Unfortunately, the pith of oranges is very bitter to the taste and accordingly oranges must be peeled before they are liquidised in this way. As mentioned above, the peeling of oranges is tricky and many people cannot be bothered to do it.

U.S. Pat. No. 4,889,044 describes a juice extractor having a hollow tube, the lower section of which has a zigzag shape and includes holes while the upper section includes a handle and a section that forms a drinking straw. In use, the bottom section is introduced into an orange through a hole and “threaded” into the fruit until the whole of the bottom section is inside the orange. The fruit and the handle are grasped and twisted relative to each other so that the bottom section breaks up the flesh inside the orange and the resulting juice can flow into the tube through the holes. It can then be consumed by sucking on the upper section of the tube.

U.S. Pat. No. 2,475,559 and U.S. Pat. No. 2,743,750 describe a fruit corer and juice extractor having a rotatable coring tube. The tube includes a pair of opposed slots and two quarter-circle blades are pivoted at the top end of the slots. The blades are movable between a position in which they extend from the corer tube and a retracted position within the corer. The tube can be inserted into the base of an orange and rotated and the blades can be extended to break up the fruit; the resulting juice runs out of the base of the orange and is collected. The entry hole into the orange is large and the path traced by the blades does not excavate and pulp the whole of the inside of the orange; also, the juice is not retained in the orange.

U.S. Pat. No. 1,002,242 describes a cabbage corer having four radially extending blades that are pivotally connected to an arbour, which is rotated by a flexible drive shaft. The corer is pressed into the cabbage stem to remove the cabbage core. The diameter of the hole can be adjusted by moving the blades outwardly or inwardly, but this swinging action only occurs in an adjustment phase and the blades are in a fixed position during the coring operation.

U.S. Pat. No. 2,5755,84 describes an industrial juice extraction machine in which oranges are held in suction cups as they are rotated on a continuous belt. While in the suction cup, a suction tube is inserted into the base of the orange. The tube is rotatable and has a pair of opposed wing blades that can be extended between a retracted position in which they are held within slots in the tube and an extended position. The use of side-by-side blades increases the width of the hole that must be made in the orange. Furthermore, the blades are limited in their motion and cannot juice the very top section of the orange.

U.S. Pat. No. 883,786 described an orange juicer which is inserted by hand into an orange. It includes a pair of side-by-side pivoted blades that can be moved from a retracted position shown in FIG. 1 to an extended position. The juicer can be rotated by hand to cut the fruit and the juice can be drunk directly through an opening in a spout.

### DISCLOSURE OF THE INVENTION

The principle of the present invention is to provide a method and apparatus for pulping the flesh of fruits within a skin using a small entrance hole so that the pulped fruit can be retained within the fruit, thereby avoiding the need for artificial packaging and presenting the fruit juice in the fruit's natural skin, which is highly appealing.

Although the present invention will be primarily described in respect of oranges, other citrus fruit can be processed using a similar arrangement, for example grapefruit. Indeed, the present invention is not limited to citrus fruit and other fruit, for example tomatoes, can be processed in a similar way to extract their juice.

In its broad concept, a first aspect of the present invention provides a rotatable shaft that includes a pulping element that can be deployed outwardly so that, when the shaft is rotated, the device pulps the flesh within the fruit.

Alternatively, according to a second aspect of the present invention, the shaft may be kept stationary and the fruit is rotated, e.g. by an electric motor.

In both aspects, the pulping element is pivotable so that it can be inserted into the fruit in alignment with the direction of insertion, so that the entry hole into the fruit can be small, but can be pivoted outwards as the shaft or the fruit rotates. This pivoting action, in combination with the rotation of the shaft or the fruit itself, traces a 3-dimensional space within the fruit that pulps the fruit, the pulp being retained within the fruit. In other words the fruit and the pulping element are rotated with respect to each other in order to pulp the flesh within the fruit.

According to the first aspect of the present invention, there is provided a method of pulping the edible flesh within a fruit, especially a citrus fruit, which method comprises
inserting an elongated pulping element having two opposed ends, e.g. a blade, into the fruit, which pulping element is pivotally attached to a rotatable shaft that has a longitudinal axis, wherein the pulping element lies alongside the shaft when the shaft and the pulping element are inserted into the fruit in the direction of the longitudinal axis of the shaft, wherein the pulping element is pivotable about an axis that is transverse to the shaft axis, which transverse axis passes through the middle of the pulping element;
rotating the shaft about its longitudinal axis relative to the fruit; and
while the shaft is rotating, pivoting the pulping element about the transverse axis, thereby causing the two opposed ends of pulping element to move outwardly from the shaft, whereby the pulping element traces a three dimensional shape within the flesh of the fruit and thereby pulps it.

In the second aspect, the fruit is rotated and the shaft is held stationary but otherwise the first and second embodiments are same, i.e. the blade is deployed from the shaft during roation to trace a three dimensional shape within the fruit and so pulp it.

In the following description, the pulping element will be generally referred to as a “blade” and, although the blade can have a sharp edge, it need not be so.

In the present specification, the action of breaking up the flesh of the fruit by the blade is described as “pulping”, irrespective of the viscosity of the final product; this same process is sometimes referred to as “liquidising” and these terms are used synonymously in this specification.

Several arrangements can be used for moving the blade outwardly from the shaft. The outward movement of the blade will then comprise pivoting the blade about the transverse axis so that the tip(s) of the blade extend laterally from the shaft. As the shaft is rotated and the blade is pivoted, it will trace a spherical shape within the flesh of the fruit and thereby pulp it.

The length of the blade will depend on the diameter of the fruit concerned. When extended laterally, it should pulp the flesh within the fruit without substantially cutting into the outside skin of the fruit. In the case of oranges and other citrus fruit, the pith, which forms the layer of the skin adjacent to the flesh, has a bitter taste and it is desirable to avoid pulping such pith with the flesh. This can be achieved by setting the length of the blade. In the case of oranges, the majority of oranges sold are approximately 80 mm to 90 mm. Therefore, it is usually possible to have a single blade length that will accommodate this range of fruit sizes while still extracting most of the flesh within the oranges in that size range. However, it is also possible to have a replaceable blade so an appropriately sized blade can be used for fruit of different diameters. Alternatively, it is possible to have a blade that can increase its length during the pulping operation, for example the blade could have a central part and tips that are extendible outwardly with respect to the central part against the action of springs; the extension of the tips could be brought about by centrifugal force, in which case the length of the blade could be controlled by the speed of rotation of the blade and the shaft. The pulping of pith can also be minimised by making the tips of the blade, which come into contact with the pith, out of a material that is more compliant, i.e. more flexible, than the rest of the blade and/or by making them less sharp so that they do not cut into the pith. In the case of a single pivotable blade, the tips can be made of a polymer material, for example nylon, while the central part of the blade can be metallic.

It is, of course, not necessary that the space that is traced by the blade should extend all the way out to the pith, in which case the very outside part of the flesh could remain unpulped. The choice of blade length will depend on a number of factors, including the variation on the diameter of the fruit, the acceptability of having a small amount of pith in the pulped fruit, the configuration of the blade, e.g. whether or not flexible tips are provided to the blades, the acceptability of leaving the outside part of the flesh unpulped, the strength of the skin of the fruit (if the skin is thin, it could collapse and it may be desirable to keep some of the fruit next to the skin unpulped to reinforce the skin and prevent it from collapsing) and how close the fruit is to being spherical. For an orange having a diameter of 80 mm, a blade length of 74 mm works well. Obviously, the same blade can be used with larger orange and will reliably produce 160 ml of pulped orange juice irrespective of the size of the fruit.

Oranges and other citrus fruit, even if not initially spherical, can be made more spherical by squeezing them between clamps that are part-spherical in shape.

The blade should be matched to the size of the fruit since if it is too large for the fruit, it can destroy the structure of the skin of the fruit and the pulp will not be retained by the skin in operation. A gauge can be included that determines whether the diameter of the fruit is too small; this can be a simple gap, e.g. in a loop, which shows that the fruit is too small if it can pass through the gap. The gauge may be a sensor on the device that assesses the diameter of the fruit when it is held ready for processing, e.g. a proximity sensor mounted alongside the fruit that assesses the fruits diameter from the distance between the fruit and the sensor.

The pivoting of the blade to the shaft about a transverse axis passing through the middle of the blade allows the blade to trace out a sphere as the shaft is rotated and the blade pivoted outwards.

Although the above discussion has centred on the use of only one blade, it is possible to have multiple blades, each pivoting about a transverse axis passing through the middle of the blade. Thus, for example, two blades can be provided that are each pivoted about a common axis in a manner similar to a pair of scissors. When the blades rather than the fruit are rotated, they are preferably rotationally balanced against each other so that, in all stages of blade extension, the shaft is balanced and vibrations are therefore minimised.

Because some variation in the diameter of the fruit is to be expected, the relative positions of the blade and the fruit can be problematic when the blades are rotated, in accordance with the first aspect of the present invention. The rotary axis of the shaft can be made coincident with the diameter of the fruit using circular holders for the fruit that centre the fruit with the shaft axis. The holders may be ring or cup-shaped.

The depth of penetration of the blade into the fruit in the first aspect of the present invention may be controlled in several ways. Firstly, the fruit can be held by a centring mechanism that will locate the centre of the fruit at a given position irrespective of the diameter of the fruit. This is more specifically described later but can be achieved by clamping the fruit between a pair of opposed springs of equal resilience. It is then possible to place the pivot of the blade in a position that is coincident with the centre of the fruit and in this way, the shape traced by the blade will always be centred within the fruit.

Secondly, the fruit could be positioned against a stop so that the place where the blade enters the fruit is at a known, fixed position. In this case, the shape of the space traced by the blade in operation will be in the same place with respect to the entry point irrespective of the diameter of the fruit. The mechanism for holding the fruit in this second alternative is simpler than the centring mechanism of the first alternative.

The fruit may also be held by horizontal clamps that centre the fruit within the clamps, e.g. by making the clamps circular, which will hold the centre of the fruit at a known vertical location.

In the first aspect, the fruit should generally be clamped during the pulping operation to prevent substantial movement of the fruit but it should not be so great as to cause the fruit to collapse in on itself once the flesh has been pulped. However, there is a limit to the force that can be withstood by the fruit, especially once the flesh has been pulped. The clamping force can be minimised by using a high friction surface on one or both of the clamps holding the fruit against rotation using high friction materials such as natural rubber, silicone rubber or Dychem, which is a specialist material based silicone rubber used in jar-opening pads; the frictional force is preferably applied as close to the “equator” of the fruit as possible to exert the highest moment of the fruit.

Alternatively, projections or spikes can be used to engage the fruit and hold it from rotation, but spikes are not preferred since they damage the surface of the fruit and can give rise to leakage of the fruit pulp.

The clamping or gripping force needs to be higher (a) when the blade is extended from the shaft as compared to when it is parallel to the shaft and (b) when the fruit is first pulped as compared to when the fruit has been liquidised. Thus a relatively low force can be tolerated when the blade is first introduced when it lies parallel to the shaft but the force may need to be increased when the blade is moved away from the shaft.

A drip tray may be placed under the fruit to catch fruit juice, which is especially beneficial when the fruit is supported on a ring or other support that cannot hold any juice that spills out from the fruit.

In the first aspect of the present invention, the bottom clamp may be a ring having an inside diameter equal to the minimum diameter of the fruit that can be pulped satisfactorily with the blade that is in use. The internal surface of the ring may be lined with high friction material, as discussed above. The ring serves two purposes, firstly to allow the fruit to be gripped close to its girth, which provides the maximum contact surface area for holding the fruit. Secondly, if a fruit is smaller than the minimum, it will fall through the ring and cannot be processed.

During the pulping operation in accordance with the present invention, the flesh of the fruit is substantially agitated and, unless the opening in the top of the fruit is closed by a seal, it is possible that the pulped fruit could escape from the inside of the fruit. The seal may be a cup that is pressed against the opening to seal it. In addition or alternatively, a seal may be provided on the shaft. This seal may have a circular edge directed towards the fruit that cuts into the skin of the fruit during the pulping operation. The cutting of the circular edge into the fruit is assisted by the relative movement between the seal and the fruit. Alternatively, the seal may be of approximately the same diameter as the entry point of the blade into the fruit and so plugs the opening in the fruit. A further alternative is to apply a seal to the orange before the blade is inserted or as part of introducing the puling device into the fruit. Such a seal may take the form of a plug that extends into the fruit and also out of the fruit in the manner of a short drinking straw; the plug has a bore through which the shaft extends during the pulping operation. After the pulping has been completed, the plug can be left in place to form an opening for a drinking straw.

The opening in the skin of the fruit through which the shaft extends may be made in a preliminary cutting operation using a special tool, e.g. a circular blade. Alternatively, the opening can be made by the blade or shaft itself in an initial step in the operation. If the opening is cut by the blade or shaft itself, then the skin cut out during this operation will generally fall into the fruit and form part of the pulp.

The shaft or fruit are preferably rotated by an electric motor and it has been found that it is best to perform the operation in two stages. In the first stage, the relative motion between the blade and the fruit drills into the fruit. The blade is then moved outwardly away from the shaft in a second stage to trace out a shape within the fruit flesh. This first stage is performed at a relatively low speed. In the second stage, the speed of the motor is increased, for example to double that in the first stage, and liquefies the fruit flesh within the space hollowed out in the first stage. The speed of the blade in the first aspect should generally be greater than 300 rpm and speeds of the order of 1,000 to 2,000 rpm are preferred.

The movement of the blade outwardly from the shaft can be brought about by centrifugal force in the first aspect of the present invention. Such movement can also be brought about by shaping the blade in such a manner that the resistance of the fruit as the blade is rotated causes the blade to move to its outwardly extended position. Therefore, the blade can be slanted with respect to a plane lying orthogonal to the rotary axis of the shaft, which will cause the blade to pivot to its outwardly extended position. However, reliance on the shape of the blade and, when the blade is rotated, centrifugal force in order to manoeuvre the blade to the outwardly extended position does not always provide a smooth transition to the fully extended position and accordingly it is preferred to include an actuator to move the blade from its initial position to its extended position. The actuator is preferably located outside of the fruit and can be connected to the blade, e.g. by a mechanical linkage such as a rod pushing a crank attached to the blade or a rack and pinion mechanism.

After the flesh of the fruit has been pulped, as described above, the blade and the shaft are removed and the resulting orange pulped juice can be consumed directly, e.g. through a drinking straw or the opening in the fruit can be sealed for later consumption, e.g. using a plug or biodegradable glue. It is also possible to empty the pulp into a container, e.g. a glass, for immediate consumption or for storage. It is also possible to remove the pulp, process it and return it later. For example, it is possible to add to the pulp sugar or other sweeteners and/or preservatives, which are preferably natural preservatives, and/or other flavourings or substances, e.g. alcohol. As an extension to this concept, it is also possible to pasteurise the juice/pulp or to make the orange pulp into, for example, a semi-frozen sorbet or ice-cream before being reintroduced back into the skin of the same or a different fruit.

One of the appealing features of the present invention is that the skin of the fruit can be used to hold the pulped fruit and it can be drunk directly from the skin and so has a “fresh” feel to it.

The device of the present invention is suitable for both commercial use and domestic use.

When electrically powered, the second aspect of the present invention, in which the fruit is rotated and the blade is stationary, is safer than the first aspect, because there is no spinning blade.

The device of the second embodiment can be arranged so that all the electronics are present in the same section as the motor and the holder, which as indicted above is preferably the base section of the device; therefore the heaviest parts can be arranged in the base, providing the device with a low centre of gravity, which makes its operation more stable. This also allows the top section to be separable from the bottom section, as no power cables need to run between the two. Further, the top and bottom sections are easy to wash—the top section can be submerged completely under water without the need for seals to prevent entry of water since it includes no electrical components. An insert may surround the fruit holder and that can be removed for cleaning purposes. The top section may include a lid that is completely transparent all the way around so that top of the fruit is visible from all angles. In this arrangement, if the motor is battery powered, the batteries can be easily accessible and hidden in the bottom section. Because there is no power in the top section, the top section can be connected to (or locked onto) the bottom section in one of a number of different angular orientations, which makes the device more user-friendly. The deployment of the blade from the axial to the lateral positions is preferably done by a manually-powered mechanism since this allows the top section to avoid containing electrical components.

### BRIEF DESCRIPTION OF DRAWINGS

There will now be described, by way of example only, three embodiments of a device in accordance with the present invention with reference to the accompanying drawings in which:

FIGS. 1 to 4 is a schematic sectional view through a first embodiment of the present invention in various stages of operation;

FIG. 5 is a perspective view through a pivotal blade used in accordance with the present invention;

FIGS. 6, 6a and 6b are an end view and two side views of the blade of FIG. 5;

FIGS. 7, 8 and 9 are (respectively) a side view, a front view and a perspective view of the end of a rotary shaft and the blade of the device of the present invention;

FIGS. 10 to 12 are a schematic sectional view of the device in accordance with a variant of the first embodiment of the present application;

FIGS. 13a and 13b illustrate a variant of the first embodiment of the present invention having two blades;

FIG. 14 is a cross-sectional view of a second embodiment of the present invention;

FIGS. 15a to b are schematic views of the blade arrangement showing the blade in an undeployed (FIG. 15a) and a deployment state (FIG. 15b);

FIG. 15c is a schematic side view of the blade arrangement taken in the direction of arrow 15c shown in FIG. 15a;

FIGS. 15d and 15e are similar to FIGS. 15a and 15b but are less schematic and show the full operation of the mechanism for deploying the blade;

FIG. 16 shows an insert that can be placed into the recess of the base section of the device;

FIG. 17 shows an optional insert for holding smaller fruit; and

FIG. 18 shows a screw-thread arrangement for deploying the blade.

### DESCRIPTION OF BEST MODE FOR PUTTING INVENTION INTO OPERATION

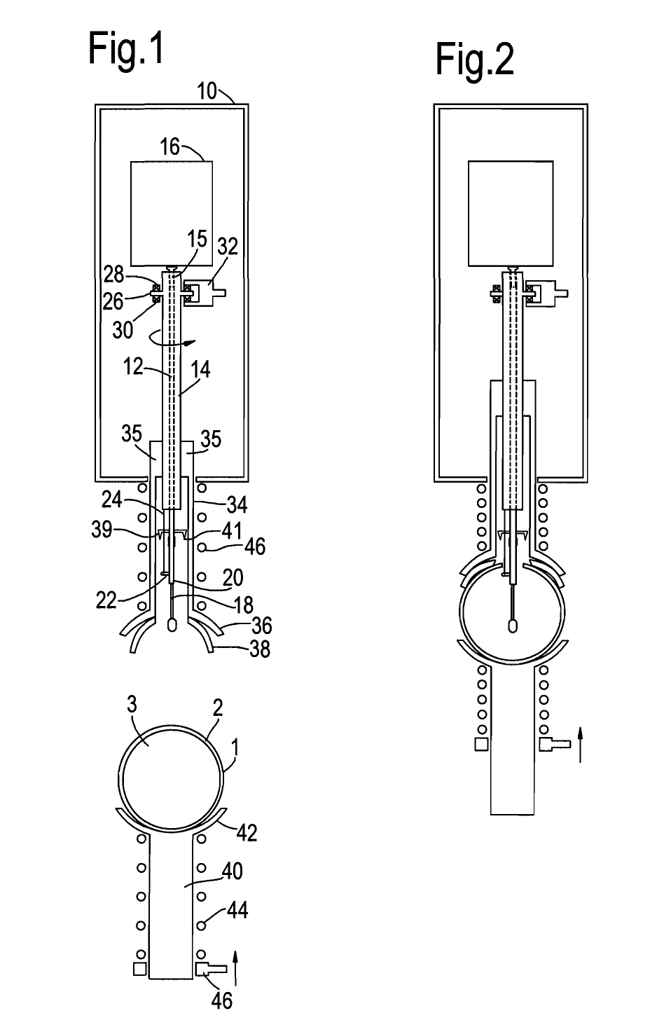

Referring initially to FIGS. 1 to 4, there is shown a device in accordance with the present invention for extracting the juice from an orange 1 that includes an outer skin 2 and the orange flesh 3.

The device includes a housing 10 containing a rotary shaft 12 and an outer sleeve 14, both of which can be rotated by an electric motor 16. Mounted at the end of the shaft 12 is a blade 18, which can pivot about an axis 20 that is orthogonal to the longitudinal axis of the shaft 12.

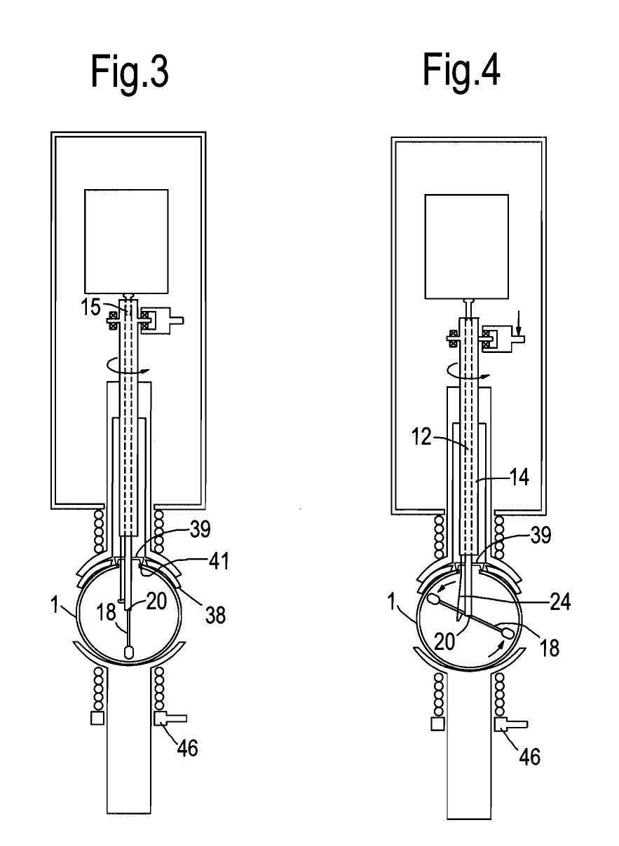

Referring now to FIGS. 5 to 9 in addition to FIGS. 1 to 4, it can be seen that the blade 18 includes a crank 22 that is pivotally connected to a rod 24 (see especially FIGS. 1, 8 and 9), which in turn is connected at its upper end to the sleeve 14. A collar 26 is provided on the sleeve that rotates between two bearings 28, 30 (see FIGS. 1 to 4). A fork 32 spans the two bearings 28, 30 on either side of the collar 26 and the fork can be moved vertically to move the sleeve up and down. The fork 32 may be moved by any mechanism, for example, a cam connected to an activating lever located outside the housing (not shown).

In FIG. 1, the blade 18 lies generally parallel to the longitudinal axis of the shaft 12 but it can be caused to extend outwardly from the shaft, as shown in FIGS. 4 and 7 to 9, by pivoting about axis 20. This pivoting movement is brought about by moving the fork 32 downwards, which moves both the sleeve 14 and the rod 24 downwards as well. The downward movement of the rod 24 causes the crank 22 to pivot the blade 18 in an anticlockwise direction (as shown in FIGS. 1 to 4 and 8 and 9).

The armature of the electric motor 16 rotates the shaft 12 directly. A spline is fixed to the top of the shaft that engages grooves on the internal surface of sleeve 14, which allows the sleeve 14 to move upwards and downwards relative to the shaft while still being rotated by motor 16. In FIGS. 1 to 4, the spline takes the form of a single pin 15 on the shaft 12 engaging in a groove on the inside surface of the sleeve 14.

At the bottom end of the housing, a shroud 34 is provided that is made of resilient plastics material. The shroud can move vertically into the housing 16 (see FIGS. 2 to 4) and the upper end of the shroud 34 surrounds the rotating sleeve 14 and provides bearing surfaces 35 to maintain the sleeve 14 in alignment with the shaft while allowing the sleeve to move upwardly and downwardly by means of the fork 32 as described above. The bottom end of the shroud 34 is flared and forms a cup 36, which clamps the top of the orange, as described below. A resilient silicone rubber seal 38, e.g. made of Dychem, is provided on the inside of the cup 36 to help maintain the seal with the orange in use and also to ensure that there is a high frictional force between the orange and the cup 36 to keep the orange from rotating.

Mounted on the shaft 20, there is a sealing device 39 having a circular sharp edge 41, the function of which will be described below.

In use, an orange 1 is placed on a lower support 40 whose upper end has a cup-shaped clamp 42 on which the orange 1 is seated. A helical spring 44 surrounds the support 40 and acts between an annular bearing 46 and the cup 42. A further helical spring 46 having identical characteristics to the spring 44 surrounds the shroud 34 and acts between the housing 10 and the cup 36.

To initiate the juicing/pulping operation, the motor 16 is started, which rotates the shaft 12, the sleeve 14 and the blade 18. In this initial period, the speed of rotation may be relatively slow, e.g. approximately 1000 rpm. Then bearing 46 is moved upwardly by a mechanism (not shown) which raises the support 40 and the orange 1 seated on it. As the orange comes into contact with the spinning blade 18, the blade makes an opening in the skin 1 of the orange and, as the support 40 is raised further by bearing 46, the blade enters into the orange, as shown in FIG. 2. During this initial contact between the blade and the orange, the orange is prevented from rotating by the friction between the orange 1 and the bottom cup clamp 42; this friction could be increased by lining the cup e.g. with a silicone rubber. As the orange is raised (see FIG. 2), it is clamped between the bottom cup 42 and the upper cup 36 with its silicone rubber seal 38. The bearing 46 is raised further beyond the position shown in FIG. 2, which causes the helical springs 44, 46 to be compressed, which increases the clamping force on the orange. This increased clamping force is desirable to resist the increased forces tending to rotate the orange when the blade 18 is moved from the vertical to the horizontal position.

The opening in the fruit will be the diameter of the shaft and the blade as the blade lies axially with respect to the shaft. This will be relatively small, e.g. in the assembly in FIG. 1, the diameter will be about 18 mm, but it can be smaller, e.g. 5 mm, or larger, e.g. up to the diameter of the fruit.

The bearing 46 is finally moved to a position such that the edge 41 of the seal 39 just digs into the skin of the orange 1 as shown in FIG. 3. This provides a seal preventing the contents of the fruit from spilling out during the pulping operation, which is supplemented by the silicone rubber seal 38.

One of the advantages of the arrangement having two spring-loaded clamping surfaces shown in FIGS. 1 to 4 is that, so long as the bearing 46 is moved to a fixed position, the centre of the orange 1 will always be located in the same place, irrespective of the diameter of the fruit. The final bearing location is set such that the pivot axis 20 of the blade 18 is located at the centre of the fruit.

Turning now to FIG. 4, in the next stage, the fork 32 is moved downwards, which causes the sleeve 14 and the rod 24 also to move downwardly. As explained above, this movement causes the blade 18 to pivot anticlockwise about pivot point 20, as shown in FIG. 4. The blade 18 is pivoted beyond the position shown in FIG. 4 until it is horizontal. Because the blade 18 is also being rotated by a shaft 12 the pivoting of the blade traces a spherical shape within the orange causing the fruit within that spherical shape to be pulped. The blade can be moved between vertical and horizontal one time or many times, depending on the amount it is desired to break up the flesh of the orange. At this stage, it is also possible to increase the speed of the motor, for example, to 2000 rpm as the resistance of the fruit decreases as a result of it being broken up by the blade 18.

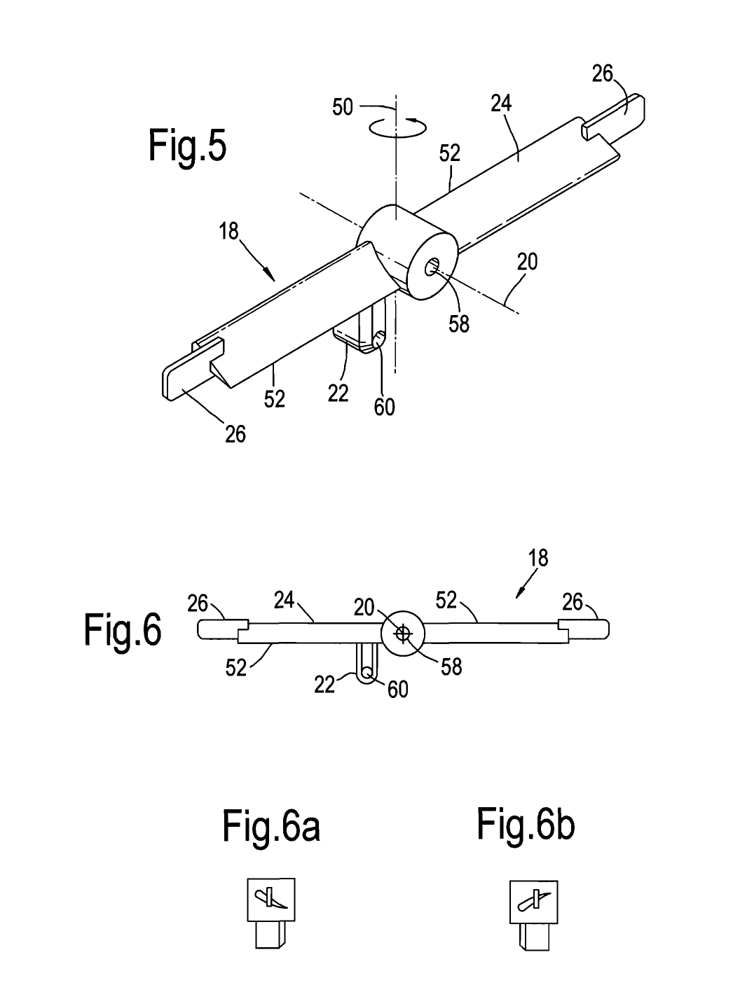

Turning now to FIGS. 5 and 6, it can be seen that the blade 18 has a central portion 24, which is made of metal and outer pads 26, which are made of nylon. The pads 24 are flexible and, if they encounter the pierce of the skin, will flex, which reduces the diameter of the blade and reduces the cutting into the pith on the inside of the skin, while also scraping the fruit off the inside of the skin.

Referring now to FIG. 6, the longitudinal axis of the shaft 12 is shown by the dashed line 50 and the blade rotates in a clockwise direction about this axis. As described above it can be pivoted about transverse axis 20 by means of a crank 22.

As can be seen particular from FIGS. 6a and 6b, the leading edges 52 of the blade as it rotates is sharpened to aid its cutting through the flesh of the fruit. The blade is also slanted with respect to a plane orthogonal to the longitudinal axis 50, which tends to cause the blade to pivot about the axis 20 into its extended position, thereby assisting the movement of the blade from the position shown in FIG. 1 to the position shown in FIG. 4. Furthermore the cross section of the blade (see FIGS. 6a and 6b) has a hydrofoil shape which further assists in the movement to the extended position. Finally, the slanting of the blade also has a greater effect in pulping the fruit flesh as compared to an unslanted blade lying in a plane orthogonal to the shaft axis.

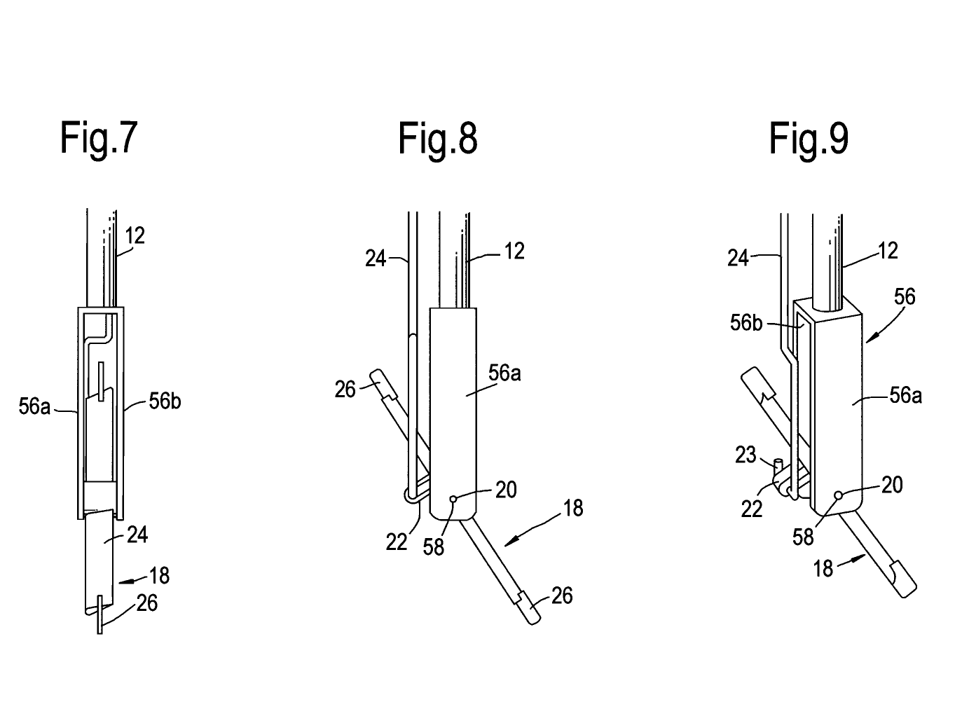

FIGS. 7 to 9 show the attachment of the blade 18 to the bottom of the shaft 12. A yolk 56 is provided at the end of the shaft having two arms 56a, 56b which fit either side of the blade 18. A pivot pin 58 extends between the arms 56a and 56b, passing through a central hole 58 in the middle of the blade 18 (see FIGS. 5 and 6). The rod 24 is engaged in a hole 60 at the remote end of the crank 22 (see FIGS. 5 and 6) and is retained in the hole 60 by means of a hooked end 23, although the rotation of the blade will tend to retain the end of the rod in the hole. When the rod 24 is pressed downwardly by moving the fork 32, the crank pivots the blade 18 about the pivot pin 58 and the axis 20, as shown.

The blade 18 is extracted from the orange by reversing the process by which it was introduced into the orange. The blade is returned to the position where it lies co-linear with the shaft, the annular bearing 46 is lowered, which causes the orange to be lowered until it is free of the blade 18, similar to the arrangement shown in FIG. 1. As the orange is removed, the shroud 34 also drops under the influence of spring 46 until it reaches the position shown in FIG. 1. The blade may be spinning during the removal operation, which cleans the blade by throwing off fruit juice by centrifugal force onto the shroud 34. Alternatively, the blade may be stopped from spinning during the removal operation.

Safety locks (not shown) may be provided that prevent the shroud 34 from being moved downwards unless the blade is vertical and prevents the blade being moved into a horizontal position unless the blade is clear of the shroud.

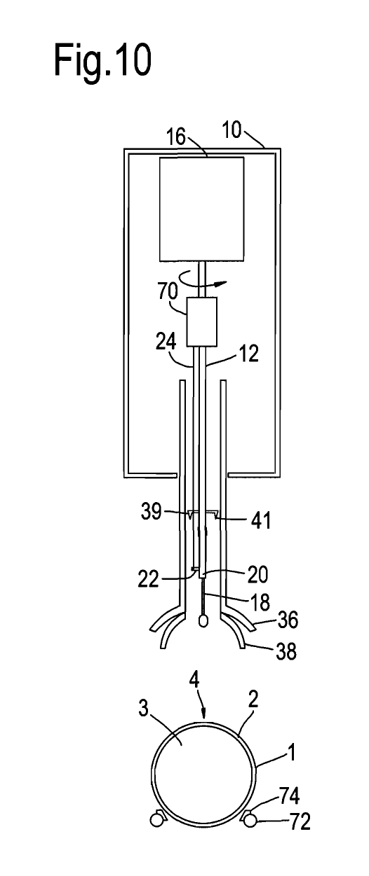

The second embodiment is shown in FIGS. 10 to 12, where features common to the first and second embodiments are shown by the same reference numbers. Thus, in the second embodiment, there is provided a housing 10 containing an electric motor that drives a shaft 12; a blade 18 is provided at the end of the shaft that is pivotable with respect of the shaft about an axis 20. The pivoting of the blade 18 is brought about by a crank 22, which is attached to the blade, which is movable by a rod 24. A slide 70 rotates with the shaft 12 and is slidable on the shaft to press the rod 24 downwardly. The movement of the slide 70 is controlled by a fork and bearings (not shown) similar in operation to fork 32 and bearings 28,30 of the first embodiment. A shroud 34 is slidable vertically into and out of the housing; the bottom of the shroud is formed as a cup 36, and a resilient seal 38 made of a high friction material, such as silicone rubber is provided on the inside of the cup 36. The shroud 34 is biased by a spring (not shown) in the downward direction.

An orange 1 is supported on a ring-shaped clamp 72 having a liner 74 made of high friction material, such as silicone rubber. The ring 72 is biased in an upward direction by a spring (not shown). This spring, when released, moves the orange 1 upwardly from the position shown in FIG. 10 until it engages the seal 38 and the cup 36. The spring is preferably a constant force spring, which provides two benefits over a normal resilient spring: firstly, the user does not have to exert a high force when the ring 72 is pulled down a substantial distance and secondly the spring still exerts a substantial force on the ring to clamp the fruit even when the ring is near the upper limit of its movement.

Because the shroud 34 is movable in a vertical direction, the spring loaded ring 72 pushes the orange 1 further upwards until the end 72 of the shroud engages the housing of the electric motor 16. When in this position, the seal 39 with its sharp edge 41 cuts into the skin 2 of the fruit, as shown in FIG. 11. During this upward movement, the motor 16 rotates both the shaft 12 and the blade 18, which cuts an opening into the orange as it is raised. When the orange is in the position shown in FIG. 11, the blade is pivoted in a clockwise direction, as shown in FIG. 12, by pushing down on the slider 17, which in turn pushes the rod 24 downwardly and causes the crank 22 to pivot the blade 18, as shown in FIG. 12. The rotation of the shaft 12 combined with the pivoting of the blade causes the blade to trace out a spherical shape, pulping the flesh of the orange 3 as it does so. The speed of the blade can be increased after an initial pulping operation to liquidise the orange.

A drip tray (not shown) may be provided below the ring to catch any drips of fruit juice that may fall.

As can be seen from FIG. 12, the top of the orange is in a known position irrespective of the size of the orange. Therefore, the axis 20 of the blade 18 will not necessarily be coincident with the centre of the orange, in contrast to the first embodiment in FIGS. 1 to 4. Thus, the sphere shape traced out by the blade 18 will be located towards the upper part of the orange if a large orange is used.

In order to extract the blade 18 from the orange, it is returned to the position where it lies co-linear with the shaft, the ring 72 is then pulled down against the action of the spring loaded arm, which causes the orange to be lowered until it is free of the blade 18, similar to the arrangement shown in FIG. 10. As the orange is removed, the shroud 34 drops under the influence of a spring (not shown) until it reaches the position shown in FIG. 10.

The blade and the bottom end of the shaft can be cleaned in situ by pushing a glass of water against the cup 36 of the shroud instead of the orange. The blade may be rotated during the cleaning process. Alternatively, the whole of the shaft 12 may be disengaged from the motor 16 for cleaning; likewise the shroud can be removed for cleaning.

If it is desired not to retain the pulp in the fruit, the method could be performed by inserting the blade though the base of the fruit and omitting the seal, in which case the pulp will flow out in use and can be collected.

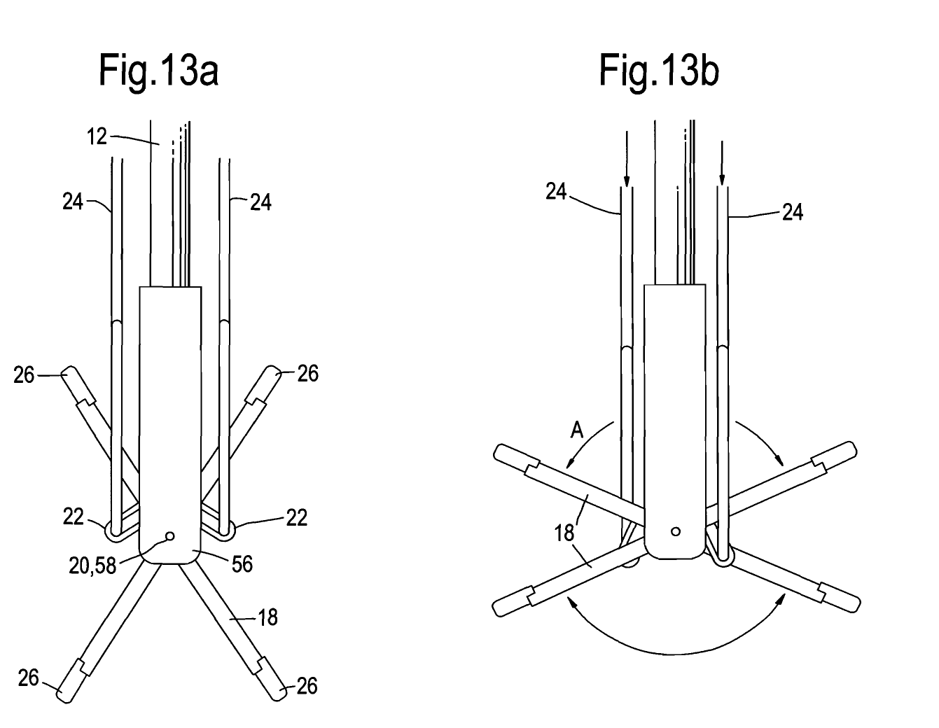

FIGS. 14 to 18 show a second embodiment of the present invention that differs from the first embodiment described in connection with FIGS. 1 to 13 in that the fruit is rotated rather than the blade.

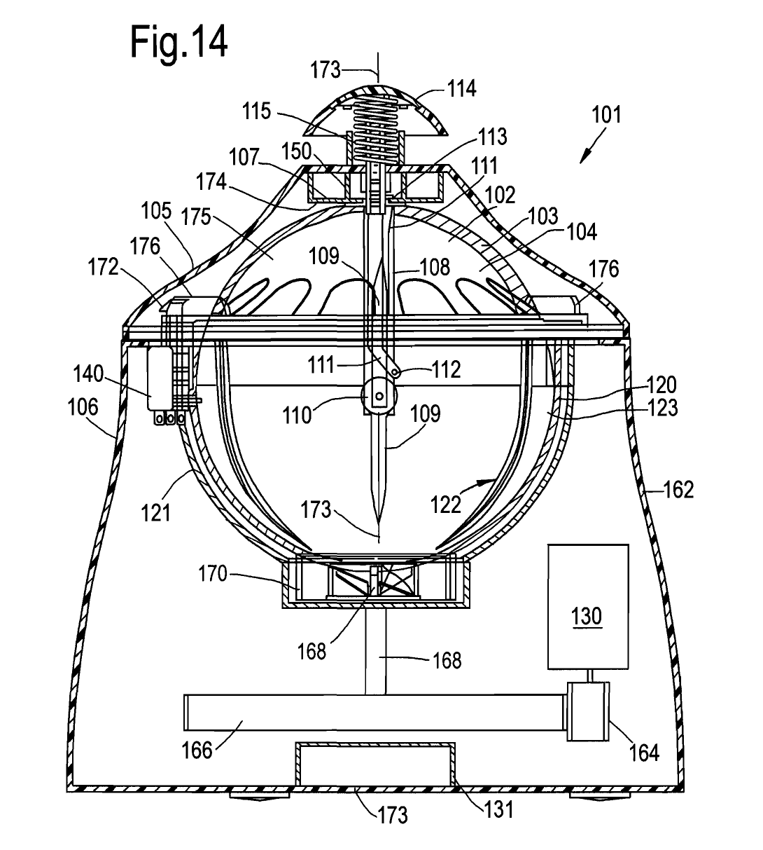

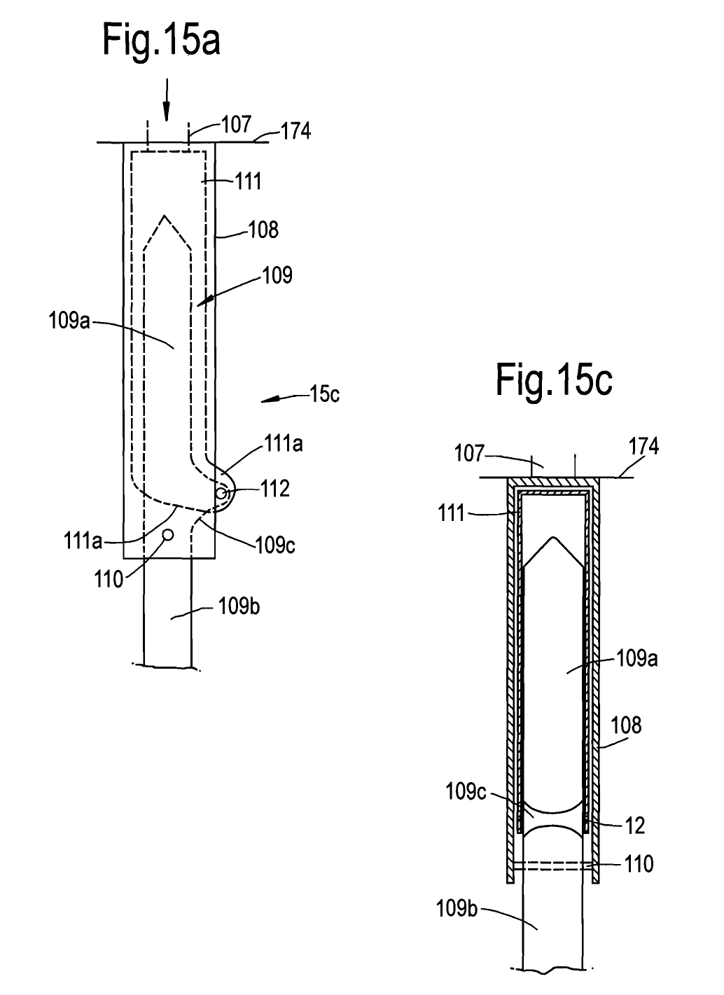

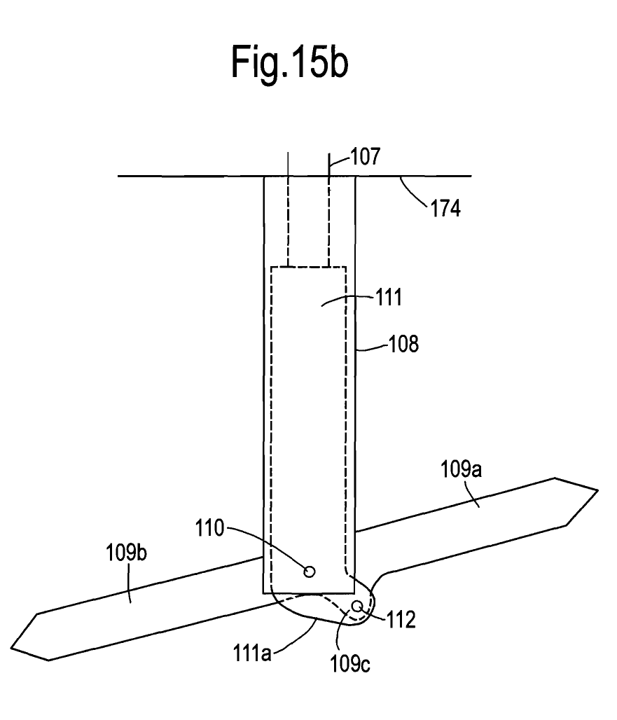

Referring initially to FIGS. 14 and 15, there is shown a device 101 in accordance with a second embodiment for extracting the juice from an orange 102 that includes an outer skin 103 and the orange flesh 104; only the skin 103 of the upper section of the orange is shown in FIG. 14; it is shown hatched.

The device includes an upper section, or ‘lid’ 105, and a base section 106. A blade frame 108 is secured to a surface 174 on the underside of the lid 105; it is forked (see FIGS. 15a to c) and extends downwardly on either side of a blade 109. The blade 109 is connected to the blade frame 108 by a pivot 110 extending through both the blade 109 and the blade frame 108; the axis of the pivot lies orthogonal to the longitudinal axis 173 of the device.

The upper section 105 contains a push button 114, which is connected to one end of a vertical shaft 107, and when the button is depressed, the shaft is moved vertically downwards. A forked arm 111 is connected to the bottom of the shaft 107 and moves vertically downwards with the shaft when the push button 114 is depressed. The two limbs of the forked arm 111 extend within the blade frame 108 between the frame and the blade (see FIG. 15c). The lower end of the arm 111 is formed into a crank 111a, which is pivotally connected by a second pivot 112 to a land 109c formed on the blade 109; the two pivots 100 and 112 are spaced apart so that when the shaft 107 is moved downwardly from the position shown in FIG. 15a, the forked crank arm 111 moves downwardly within the frame 108 to the position shown in FIGS. 15b and 15e, causing the blade to turn about pivot 110 in the clockwise direction (as viewed in FIGS. 15a and 15d).

A spring 115, for example a coil/helical spring, is provided that is compressed when the button is pushed downwards; the spring biases the button upwardly so that, when the downward pressure on the button is released, the spring moves the button 114, and the crank arm 111 upwards, thereby causing the above-described operation to be reversed and returning the blade to the axial position shown in FIGS. 15a and 15d. The button is preferably centrally located on the top of the lid, on the longitudinal axis 173.

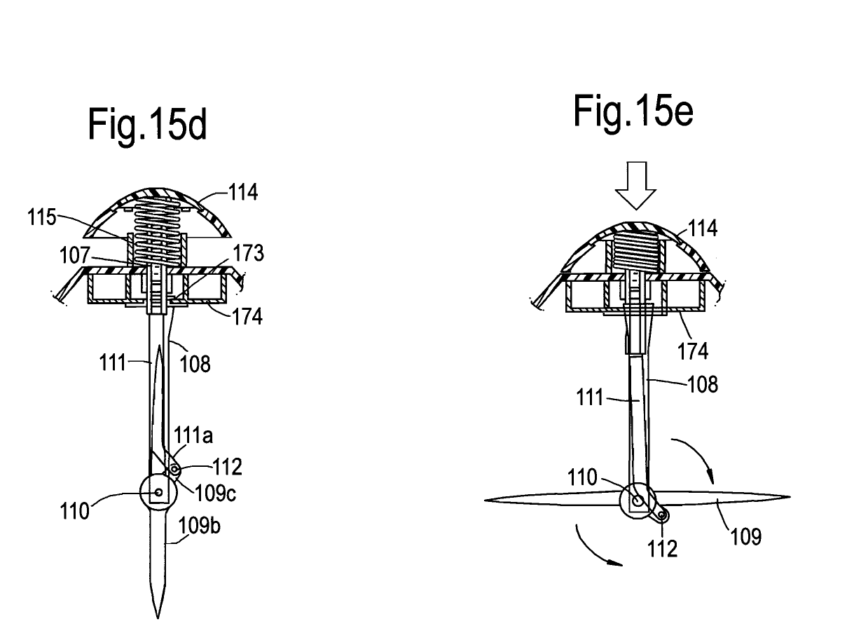

The base section 106 comprises a static housing comprising an outer wall 162 and an inner wall 121, which forms a concave recess above it. Within the recess, there is an insert 120 that can be removed from the housing for washing. It provides a solid wall that retains juice and fruit fragments and prevents them from reaching the static inner wall 121 so that the rest of the base section does not need to be washed after use. The insert 120, which is shown in FIG. 16, has ribs 122 that can engage an orange snugly; the ribs and the sloping sidewalls of the insert 120 allow the insert to accommodate slight variations in the diameters of the fruit used and the ribs assist in gripping the fruit. The insert may also be provided with a high friction coating, e.g. silicone rubber, on its concave inner surface 123, which comes into contact with the fruit.

The space between the inner and outer walls 162,121 is sealed, that is to say it is water-tight and includes an electric motor 130 is located in this space, which is driven by batteries (not shown) in compartment 131 or alternatively by connection to a mains power supply (not shown). The motor rotates a planetary arrangement of gears (only gear 164 is shown), which in turn rotates a larger gearwheel 166 that is rotatably secured to the base 106 (the bearing arrangement for gearwheel 166 is not shown). The gears 166 turn an integral shaft 168 that in turn rotates a cup 170 that is frictionally engaged with the bottom of the insert 120. Frictional engagement between the insert 120 and the cup 170 can be increased by shaping the surface of the cup to match the corresponding surface of the insert and also by coating one or both of these surfaces with a high friction material such as rubber. Alternatively, the base of the insert may be provided with projections that project into corresponding recesses in the top of the cup (or vice versa) to ensure that the insert is driven by the rotating cup.

The fruit may be pressed against the insert 120 by the lid 105, which may be provided with a rotating or stationary resilient element 175 for that purpose, which also seals the opening in the fruit during pulping (see below). In use, an orange 102 is placed into the cup-shaped insert 120 of the base section 106. The blade 109, which is connected to the underside of the lid 105, is stabbed into the orange 102 to penetrate the skin and is then pushed into the fruit so that the whole of the blade 109 is located within the fruit, and the lid 105 is then secured onto the base section 106. Optionally an opening in the skin of the orange may be made by another tool (see below) to assist with the insertion of the blade 109 into the fruit.

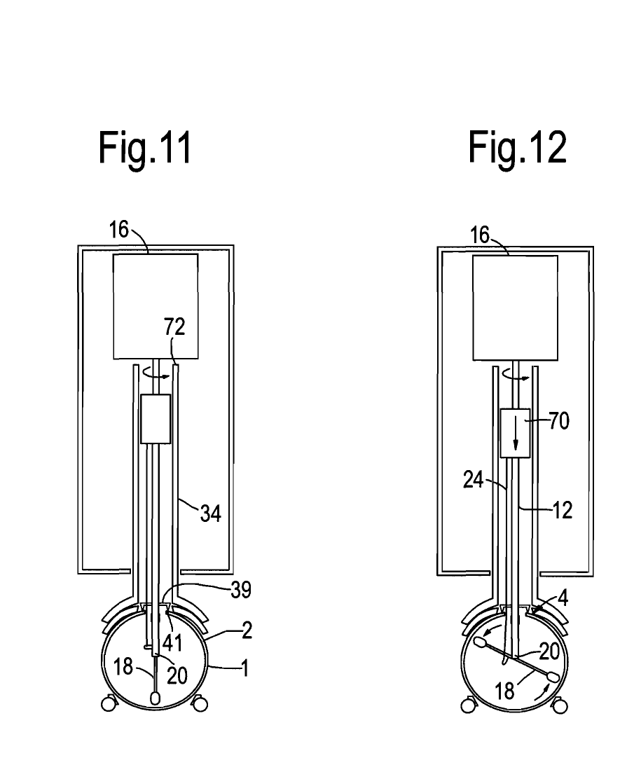

The opening in the fruit will have the approximately the same area as the cross section of the blade frame 108 and the blade 109 as the blade lies co-axially with respect to the blade frame during insertion. This opening will be relatively small, e.g. in the assembly in FIG. 13, the diameter will be about 5 to 10 mm, but it can be smaller, e.g. 3 mm, or larger, e.g. nearly up to the diameter of the fruit.

Referring now principally to FIG. 14, it can be seen that the blade 109, when it is first inserted into the fruit (FIG. 15a), is in its axial resting position and one end 109a of the blade is contained within the frame 108 while the other end 109b extends downwardly parallel to the shaft 107.

The lid can be fastened to the base in a liquid tight manner, e.g. by proving a bayonet joint between the base and the lid. During the fastening of the bayonet joint 175, a projection 172 in the lid activates a micro-switch 140 located inside the base 106 which in turn starts the motor 30 that rotates the insert 120 about the vertical axis 173. At this stage, the orange is being spun around the longitudinal axis of the blade 109, and the blade is stationary in its axial resting position.

The user then applies a downwards force to the button 114 located on the lid 105, which causes the shaft 107 and the crank arm 111 to move downwardly, which in turn pushes down on the pivot 112 between the crank 111a and the blade and causes the blade 109 to begin to pivot in a clockwise direction (as seen in FIG. 14) away from its resting position into the unpulped flesh of the orange 102. The pushing down of the knob also compresses the spring 115.

The resilient element 175 within the lid 105 or the surface 174 can form a seal (not shown) around the shaft 107, when it is pressed against the top of the fruit as it is rotated. This seal closes the opening in the top of the fruit and prevents the juice from spilling out during the pulping operation.

Further downwards movement of the button 114 causes the crank arm 111 to move further downwardly, causing the blade 109 to pivot about pivot point 110, see FIG. 15b. The blade 109 can be pivoted beyond the position shown in FIG. 15b until it is slightly beyond horizontal, e.g. about 10° beyond the horizontal. Because the orange 102 is being rotated, the pivoting of the blade traces a spherical shape within the orange causing the flesh 104 of the fruit within that spherical shape to be pulped. The blade can be moved between vertical and the slightly beyond horizontal one time or many times, depending on the amount it is desired to break up the flesh of the orange. At this stage, the speed of the motor can increase, for example, to 2000 rpm as the resistance of the fruit decreases as a result of the flesh being broken up by the blade 109.

It is desirable for the blade to be able to pivot beyond 90° from its resting position to prevent the possible occurrence of a ring of unpulped orange remaining around the interior ‘equator’ of the orange, which may be caused by several reasons, including the orange moving slightly during juicing. Consequently the entire orange that is in reach of the ends of the blade will be pulped. A problem with having unpulped orange remaining around the interior equator of the orange (in addition to the intrinsic loss of pulped fruit) is that thicker juice from the bottom blade path can be caught below this unpulped orange which makes it difficult to extract; the removal of the unpulped equator alleviates this problem.

The device may be configured to produce a discernible signal, e.g. an audible click, to indicate to the user that the blade has reached or travelled beyond the 90° point. This will prevent users stopping short of the full length of travel of the blade because they mistakenly think they have extended the blade far enough.

The blade 9 may have the same configuration as described in connection with FIG. 6 with pads on the end of the blade. However, it is possible that only the end of the blade (generally the end within the blade frame 108 when the blade is in its resting position of FIGS. 15a and 15d) has a pad 156 so that the benefit of avoiding breaking up the pith is achieved; the other end can provide a blade tip that is able to pierce through the outer skin of the orange, as discussed above.

After juicing, the motor 130 may be stopped by turning the lid 105 a few degrees relative to the base section, in the opposite direction to that used to start the motor, e.g. in an anti-clockwise direction. The insert then stops spinning almost immediately because of the presence of the blade within the fruit. The arrangement is preferably such that the lid is locked onto the base 106 all the time while the projection in the lid 172 activates the micro-switch 140 and preferably also after the projection has stopped engaging the microswitch, which may be achieved by positioning the projection 172 appropriately with respect to the bayonet joint 175.

Before, during or after the stopping of the motor, the force applied to the button 114 on the lid 105 is removed, so that the blade returns to its longitudinal resting position under the influence of spring 115. The lid 105 can only be separated from the base once:

a) the pressure on the push button 114 has been be removed;

b) the microswitch has been deactivated, thereby stopping the motor by turning the lid; and

c) the lid has been turned to remove the projection from the bayonet groove.

The removal of the lid from the base also removes the blade 109 from out of the liquidised orange pulp. Since at this stage, the pressure on the push button 114 has been removed, the blade will be in the axial position shown in FIG. 15a and so it can be lifted through the narrow opening in the top of the orange. The insert 120 will catch any drips of fruit juice that may leak out of the orange.

A master on/off switch (not shown) is also provided on the base of the device so that the device can be stored safely with the lid on. It is thus not possible for the insert to start spinning by accidental activation of the micro-switch by turning the lid, when the device has been switched off using the master on/off switch.

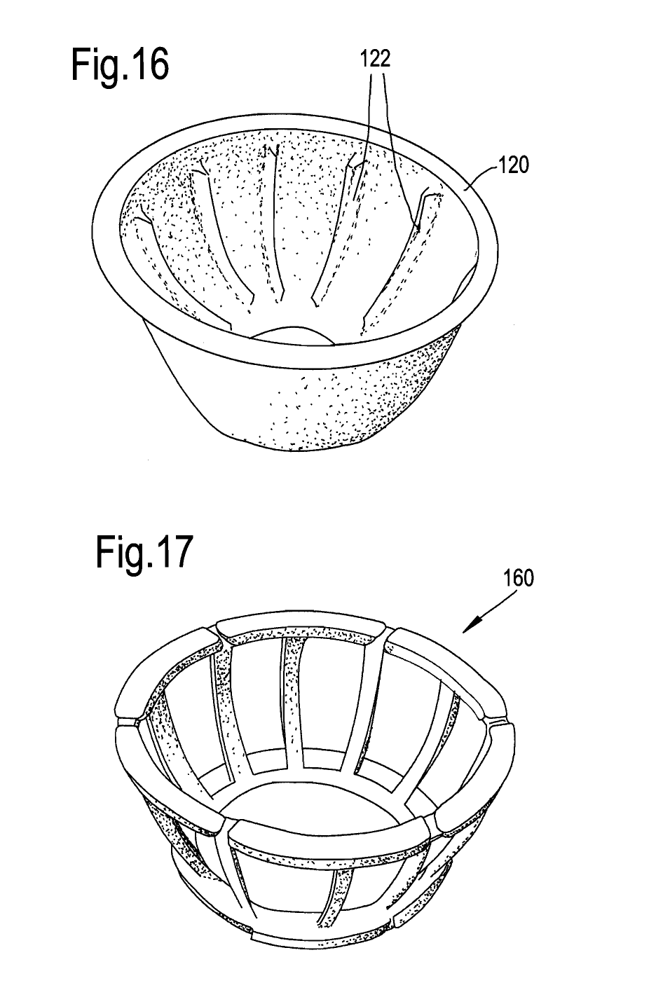

As shown in FIG. 17, the device of the present invention may include a basket 160 that fits into the insert 122 in the base section. This basket 160 is able to accommodate smaller fruit e.g. an orange with a smaller diameter.

A tool may be provided to make a small incision in the orange before juicing to allow the blade to be pushed into the fruit without requiring the blade 109 to break the skin.

In summary, the spinning of the fruit is started by placing the top part, or lid 105, onto the base of the device, thereby also inserting the blade into the orange. Once the lid is on, the user turns the lid relative to the bottom of the device. This engages a micro-switch which in turns activates the motor to spin the orange. The user then presses the button on top of the device to deploy the blade. One of the user's hands is free to stabilise the device while the other hand applies a downward force on the button 114. This will contain any vibration caused by the spinning of the orange.

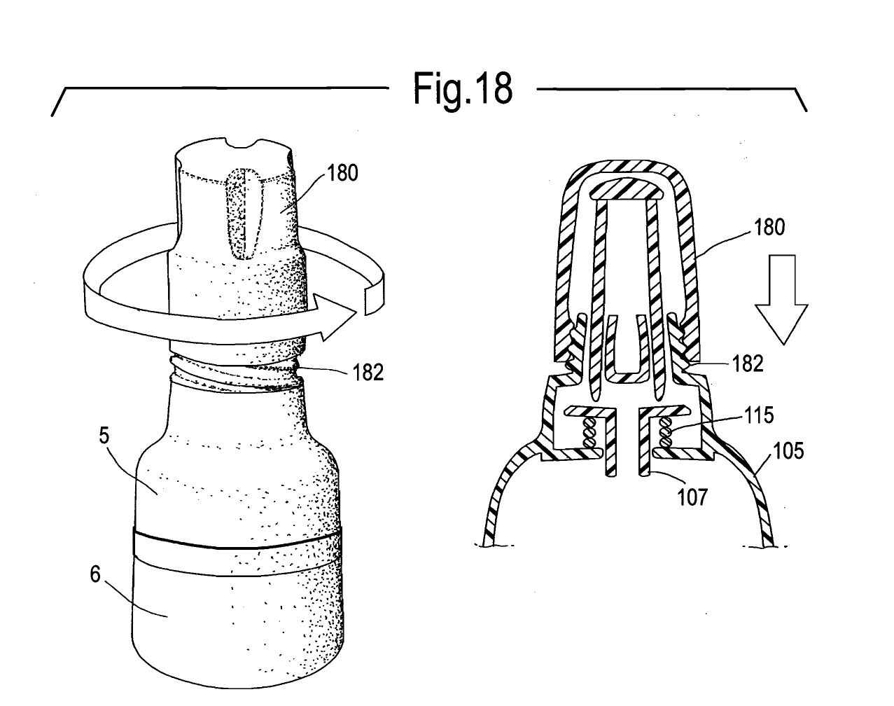

In the embodiment described above, the user pushes on the top of the device in order to move the blade. This can require a lot of force and may be difficult for some users. If necessary, a lever may be provided to assist. However, in an alternative embodiment of the invention, the deployment of the blade may be brought about by a screwing action rather than a pushing action. FIG. 18 shows an alternative to the lid in which the shaft 107 and the crank 111 (not shown) are pushed downwards by turning a knob 80 that is connected to the lid by a screw thread 182 and it is possible to generate a considerable downwards force on the crank 111 in this way. If the thread is very coarse, it is possible to get the blade to travel from its vertical position to its fully extended position out of one single turn of the knob. A spring 115 is provided that acts between the shaft 107 and the lid 105 which is compressed when the turned knob is screwed down and which can lift the shaft 107 when the knob is screwed up. It therefore acts in the same way as spring 15 of the first embodiment described in connection with FIGS. 13 to 16.

The device may be battery powered or could be mains powered or the device could be provided with both sources of power with the device being provided with the means to draw power from either source, so that the user has the option of using the device by connecting it to a mains power source, e.g. at home, or using it as a portable battery operated device.

The device could be hand-powered to turn the fruit but this is not preferred since it is then difficult to stabilise the device in use.

The exterior of the device is made of a resilient material, for example a plastics material, a metal or an alloy, such as stainless steel. The lid is for example made of polycarbonate (PC). The base is for example made of polypropylene (PP). The internal parts of the device, such as the components of the drive gear, the gear frame and the motor, are made of any standard material used for these devices, for example nylon.

In a further alternative embodiment of the present invention, the blade is positioned in the bottom part of the device extending in an upwards direction. The blade thus extends upwards through a hole located in the internal surface of the bottom half of the device. This could allow the juice to run out of the fruit during pulping. Similarly, the device may be mounted so that the blade extends horizontally.

What is claimed is:

1. A method of pulping the edible flesh within a fruit, especially a citrus fruit, which method comprises:
providing an elongated pulping element having two opposed ends, which pulping element is attached to a rotatable shaft that has a longitudinal axis, wherein the pulping element is pivotable about an axis that is transverse to the shaft axis, which transverse axis passes through the middle of the pulping element,
inserting the shaft and the pulping element into the fruit in the direction of the longitudinal axis of the shaft, wherein the pulping element lies alongside the shaft;
rotating the shaft about its longitudinal axis relative to the fruit; and
while the shaft is rotating, pivoting the pulping element about the transverse axis, thereby causing the two opposed ends of pulping element to move outwardly from the shaft, whereby the pulping element traces a three dimensional shape within the flesh of the fruit and thereby pulps it.

2. A method as claimed in claim 1, wherein the pulping element is moved outwardly by an actuator located outside of the fruit.

3. A method as claimed in claim 1, wherein the pulping element is slanted with respect to a plane lying orthogonal to the rotary axis of the shaft such that, as it is rotated about the shaft axis, the resistance of the fruit causes the element to move towards its outwardly extended position.

4. A method as claimed in claim 1, wherein a pair of pulping elements is provided, each element being pivotable about an axis that is transverse to the shaft axis, which transverse axis passes through the middle of each pulping element.

5. A device for pulping the edible flesh within a fruit, especially a citrus fruit, which device comprises:
a rotatable shaft that has a longitudinal axis;
an elongated pulping element attached to the shaft and pivotally movable with respect to the shaft about an axis that passes through the middle of the element;
wherein the pulping element is movable between a first position in which it lies generally alongside the shaft and a second position in which it has moved away from the shaft,
whereby the pulping element and the shaft can be inserted into a fruit along the direction of the longitudinal axis of the shaft with the pulping element in the first position and, by rotating the shaft about its longitudinal axis and causing the pulping element to pivot outwardly away from the shaft about the transverse axis to the second position while the shaft is rotating, the pulping element can trace a three dimensional space within the fruit and so pulp the flesh of the fruit within that space.

6. A device as claimed in claim 5, wherein the pulping element is slanted with respect to a plane lying orthogonal to the rotary axis of the shaft such that, as the element is rotated about the shaft axis, the resistance of the fruit causes the element to move towards its outwardly extended second position.

7. A device as claimed in claim 6, wherein the pulping element has a hydrofoil shape in cross section.

8. A device as claimed in claim 5, wherein the pulping element has a leading edge as it is rotated by the shaft about the shaft axis, which leading edge is optionally sharpened to cut through the fruit.

9. A device as claimed in claim 5, wherein the pulping element is of variable rotation diameter and has a central part and opposed end parts that are more compliant as compared to the central part, whereby the ends can flex in use and so shorten the rotation diameter of the pulping element.

10. A device as claimed in claim 5, which includes a seal located in a position remote from the end of the shaft such that it can seal the point of entry of the shaft and the pulping element into the fruit during the pulping operation.

11. A device as claimed in claim 5, which comprises a clamp for holding the fruit, which comprises a clamping surface comprising a high friction material to resist the fruit being turned with the shaft and pulping element.

12. A device as claimed in claim 5, which comprises projections or spikes for engaging the fruit to resist the fruit being turned with the shaft and pulping element.

13. A device as claimed in claim 5, wherein a pair of pulping elements is provided, each element being pivotable about an axis that is transverse to the shaft axis, which transverse axis passes through the middle of each pulping element.

14. A device for pulping the edible flesh of a fruit, the device comprising:
a first section comprising a holder configured to hold the fruit and means for rotating the holder and any fruit held by it; and
a second section, the first and the second sections being movable relative to each other along an axial direction to bring the two sections together, the second section comprising:
a pulping element that is pivotable between an axial position in which the element lies generally along the said axial direction, and a lateral position in which the element extends laterally with respect to the axis; and
means for moving the pulping element between the axial position and the radial position;
the arrangement being such that the edible flesh of a fruit can be pulped by locating the element in the fruit, rotating the fruit in the holder and pivoting the pulping element between the axial position and the lateral position so that the pulping element traces out a volume in the fruit as it pivots and as the fruit rotates, thereby pulping the flesh of the fruit.

15. A device as claimed in claim 14, wherein the first and the second sections are engageable with each other to form a closed cavity containing the holder and any fruit held by it.

16. A device as claimed in claim 15, which includes a switch for activating the motor and wherein the switch is configured to activate the motor only when the two sections have been engaged with each other to form the said closed cavity.

17. A device as claimed in claim 14, wherein the first section forms the base of the device.

18. A device as claimed in claim 17, wherein all electrical components of the device are provided in the first section.

19. The device claimed in claim 14, wherein the means for pivoting the pulping element between the axial and the lateral positions is a manually-powered mechanism.

20. The device claimed in claim 19, wherein the means for pivoting the pulping element is selected from the group consisting of a push button, a lever and a screw mechanism configured such that screwing and unscrewing the mechanism causes the pulping element to pivot between said axial and the lateral positions.

21. The device claimed in claim 14, wherein the means for pivoting the pulping element is configured to return to the pulping element to the axial position.

22. The device as claimed in claim 14, wherein the pulping element is pivotable from the axial position by an angle that is at least 90°.

23. The device as claimed in claim 1, wherein the pulping element comprises a blade having two opposed ends.

24. The device as claimed in claim 5, wherein the pulping element comprises a blade having two opposed ends.

25. The device as claimed in claim 14, wherein the pulping element comprises a blade having two opposed ends.

26. A method of pulping the edible flesh within a fruit, especially a citrus fruit, which method comprises:
inserting a pulping element into the fruit along an axial direction, the pulping element being pivotable between an axial position in which the element lies generally along the said axial direction and a lateral position in which the element extends laterally with respect to the axis, wherein the pulping element is in the axial position while being inserted into the fruit;
rotating the fruit and, while the fruit is rotating, moving the pulping element between the axial position and the radial position so that the pulping element traces out a volume in the fruit as it pivots and as the fruit rotates, thereby pulping the flesh of the fruit.
